(19) United States
(12) Patent Application Publication
(10) Pub. No.: US 2010/0156760 A1
(43) Pub. Date: Jun. 24, 2010

(54) MOTION CONTROLLED MULTIMEDIA CONTENT VIEWING METHOD AND SYSTEM

(75) Inventor: William Roberts Cheswick, Bernardsville, NJ (US)

Correspondence Address: AT&T Legal Department - JW;Attn: Patent Docketing, Room 2A-207, One AT&T Way, Bedminster, NJ, 07921, US

(73) Assignee: AT&T INTELLECTUAL PROPERTY I, L.P., Reno, NV (US)

(21) Appl. No.: 12/340,377

(22) Filed: Dec. 19, 2008

(51) Int. Cl. G09G 3/00

(52) U.S. Cl. 345/31

(57) ABSTRACT

A method and system for controlling display of multimedia content. A request to display a multimedia program is received, a motion state of a display enablement device (DED) is determined, and based on the motion state of the DED, a determination is made whether to respond to the display request by providing the multimedia program for display. A determination may be made to provide the multimedia program for display for so long as the motion state of the DED is continually changed. A determination may also be made to provide the multimedia content for so long as the motion state of the DED is continually changed in accordance with a selected pattern. A determination may also be made to provide the multimedia content if a relatively constant motion state of the DED is maintained for a selected time period.

### BACKGROUND

1. Field of the Disclosure

The present disclosure relates to exercising and, more particularly, to exercising while watching multimedia content.

2. Description of the Related Art

Multimedia content is typically viewed on a television or other type of display device such as computer or portable multimedia content player. Typically, when such multimedia content is viewed, the viewer is in a relatively stationary or otherwise inactive position.

### BRIEF DESCRIPTION OF THE DRAWINGS

FIG. 1 is a block diagram of selected elements of an embodiment of a multimedia distribution network;

FIG. 2 is a block diagram of selected elements of an embodiment of a multimedia distribution network;

FIG. 3 is a block diagram of selected elements of an embodiment of a multimedia handling device; and

FIG. 4 illustrates an embodiment of a system for controlling viewing of multimedia content.

### DESCRIPTION OF EXEMPLARY EMBODIMENTS

In one aspect, a disclosed method for displaying multimedia content received over a multimedia content distribution network (MCDN) includes receiving multimedia content from the MCDN and in response to receiving a request to display a multimedia program, determining a motion state of a handheld display enablement device. Based on the motion state of the display enablement device, a determination is made whether to respond to the display request by providing the multimedia program for display (i.e., displaying the multimedia program). In one embodiment, the display enablement device may be held in the a user's hand, movement of the display enablement device may be controlled by the user, and the determination of the motion state is conducted on a recurring basis. In another embodiment, the display enablement device may be configured to determine movement of a user without being in physical contact with the user. In response to determining not to display the multimedia program, a communication to a user to move, or to move the display enablement device, may be effected.

In some embodiments, the method includes no longer displaying the multimedia program upon determining that the motion state for the display enablement device is invalid for a threshold duration. The first predetermined threshold may be increased in response to determining that a duration of displaying the multimedia program exceeds a second predetermined threshold. Effecting the increase in the first predetermined threshold may be communicated to a user (i.e., viewer of the multimedia program).

In some embodiments, the method may include displaying the multimedia program for so long as the position of the display enablement device is changed. Displaying the multimedia content may also be conditioned on the user continually moving the display enablement device within a selected speed range. The selected speed range may be changed in response to previous movements of the user and the changed speed range may be communicated to the user. In some embodiments, displaying the multimedia content may be conditioned on movement of the user in addition to, or instead of, movement of the display enablement device.

The method may include displaying the multimedia program for so long as the user continually changes the position of the display enablement device in accordance with a selected pattern. In response to previous movements of the display enablement device by the user, the selected pattern may be changed and the changed pattern may be communicated to the user. Displaying the multimedia program may also occur as long as the user maintains a relatively constant motion state of the display enablement device for a selected time period. In response to the user previously maintaining a relative constant motion state of the display enablement device, the selected time period may be changed and the changed time period may be communicated to the user.

In some embodiments, the method may include displaying the multimedia program based in part upon a position of the display enablement device relative to a predetermined part of the user's body. The predetermined body part may be at the end of the user's extended arm.

In another aspect, a disclosed system for controlling display of multimedia content includes a processor, and storage accessible to the processor, including processor executable instructions. The instructions may be executable to receive a request to display a multimedia program, communicate a message to move a display enablement device, continually determine a motion state of the display enablement device, and continually determine, based on the motion state, whether to respond to the display request by forwarding the multimedia program to a display device.

In some embodiments, the system further includes instructions executable to provide a message to move the display enablement device in response to detecting an invalid motion state and responsive to detecting an invalid motion state for a predetermined time period, cease forwarding the multimedia content to a display device (i.e., no longer display the multimedia content). In some embodiments, the duration of the predetermined time period is dependent on the type of multimedia program being displayed. In yet additional embodiments, the motion state is valid while the user continually changes the position of the display enablement device or while the user maintains a relatively position of the display enablement device for a selected time period.

In yet a further aspect, computer-readable memory media, including processor executable instructions for controlling display of multimedia content, may include instructions executable to continually detect a motion state of a display enablement device, continually determine whether said motion state is valid, and responsive to a valid motion state, provide a multimedia program for display.

In some embodiments, the instructions are executable to provide a message to move the display enablement device in response to an invalid motion state and to cease displaying the multimedia program in response to a continually invalid motion state occurring for a predetermined time period. The predetermined time period may be adjusted based upon the type of multimedia program. In one embodiment, the adjustment may result in an increase of the predetermined time period. The adjustment may be based upon the multimedia program being classified within a preferred viewing class. The motion state is valid while the position of the display enablement device is continually changed. In an additional embodiment, the motion state may be valid when the motion state of the display enablement device is maintained in a relatively constant position for a predetermined period of time (e.g., at the end of a user's extended arm).

In the following description, details are set forth by way of example to facilitate discussion of the disclosed subject matter. It should be apparent to a person of ordinary skill in the field, however, that the disclosed embodiments are exemplary and not exhaustive of all possible embodiments. Throughout this disclosure, a hyphenated form of a reference numeral refers to a specific instance of an element and the un-hyphenated form of the reference numeral refers to the element generically or collectively. Thus, for example, widget 12-1 refers to an instance of a widget class, which may be referred to collectively as widgets 12 and any one of which may be referred to generically as a widget 12.

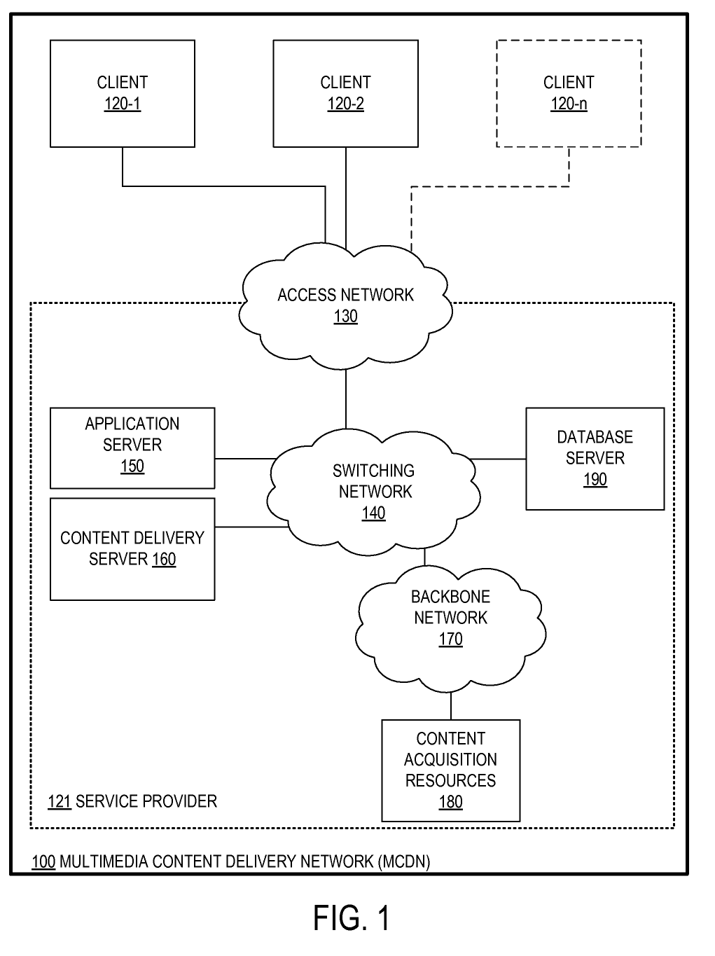

Turning now to the drawings, FIG. 1 is a block diagram illustrating selected elements of an embodiment of an MCDN 100. Although multimedia content is not limited to TV, video on demand (VOD), or pay-per-view programs (PPV), the depicted embodiments of MCDN 100 and its capabilities are primarily described herein with reference to these types of multimedia content, which are interchangeably referred to herein as multimedia content, multimedia content program(s), multimedia programs or, simply, programs.

The elements of MCDN 100 illustrated in FIG. 1 depict network embodiments with functionality for delivering multimedia content to a set of one or more users. It is noted that different embodiments of MCDN 100 may include additional elements or systems (not shown in FIG. 1 for clarity) as desired for additional functionality, such as data processing systems for billing, content management, customer support, operational support, or other business applications.

As depicted in FIG. 1, MCDN 100 includes one or more clients 120 and a service provider 121. Each client 120 may represent a different user of MCDN 100. In FIG. 1, a plurality of n clients 120 is depicted as client 120-1, client 120-2 to client 120-n, where n may be a large number. Service provider 121 as depicted in FIG. 1 encompasses resources to acquire, process, and deliver programs to clients 120 via access network 130. Such elements in FIG. 1 of service provider 121 include content acquisition resources 180 connected to switching network 140 via backbone network 170, as well as application server 150, database server 190, and content delivery server 160, also shown connected to switching network 140.

Access network 130 demarcates clients 120 and service provider 121, and provides connection path(s) between clients 120 and service provider 121. In some embodiments, access network 130 is an Internet protocol (IP) compliant network. In some embodiments, access network 130 is, at least in part, a coaxial cable network. It is noted that in some embodiments of MCDN 100, access network 130 is owned and/or operated by service provider 121. In other embodiments, a third party may own and/or operate at least a portion of access network 130.

In IP-compliant embodiments of access network 130, access network 130 may include a physical layer of unshielded twist pair cables, fiber optic cables, or a combination thereof. MCDN 100 may include digital subscriber line (DSL) compliant twisted pair connections between clients 120 and a node (not depicted) in access network 130 while fiber, cable or another broadband medium connects service provider resources to the node. In other embodiments, the broadband cable may extend all the way to clients 120.

As depicted in FIG. 1, switching network 140 provides connectivity for service provider 121, and may be housed in a central office or other facility of service provider 121. Switching network 140 may provide firewall and routing functions to demarcate access network 130 from the resources of service provider 121. In embodiments that employ DSL compliant connections, switching network 140 may include elements of a DSL Access Multiplexer (DSLAM) that multiplexes many subscriber DSLs to backbone network 170.

In FIG. 1, backbone network 170 represents a private network including, as an example, a fiber based network to accommodate high data transfer rates. Content acquisition resources 180 as depicted in FIG. 1 encompass the acquisition of various types of content including broadcast content, other “live” content including national content feeds, and VOD content.

Thus, the content provided by service provider 121 encompasses multimedia content that is scheduled in advance for viewing by clients 120 via access network 130. Such multimedia content, also referred to herein as “scheduled programming,” may be selected using an electronic programming guide (EPG). Some scheduled programs may be “regularly” scheduled programs, which recur at regular intervals or at the same periodic date and time (i.e., daily, weekly, monthly, etc.).

Acquired content is provided to content delivery server 160 via backbone network 170 and switching network 140. Content may be delivered from content delivery server 160 to clients 120 via switching network 140 and access network 130. Content may be compressed, encrypted, modulated, demodulated, and otherwise encoded or processed at content acquisition resources 180, content delivery server 160, or both. Although FIG. 1 depicts a single element encompassing acquisition of all content, different types of content may be acquired via different types of acquisition resources. Similarly, although FIG. 1 depicts a single content delivery server 160, different types of content may be delivered by different servers. Moreover, embodiments of multimedia content delivery network 100 may include content acquisition resources in regional offices that are connected to switching network 140.

Although service provider 121 is depicted in FIG. 1 as having switching network 140 to which content acquisition resources 180, content delivery server 160, and application server 150 are connected, other embodiments may employ different switching networks for each of these functional components and may include additional functional components (not depicted in FIG. 1) including, for example, operational subsystem support (OSS) resources.

FIG. 1 also illustrates application server 150 connected to switching network 140. As suggested by its name, application server 150 may host or otherwise implement one or more applications for MCDN 100. Application server 150 may be any data processing system with associated software that provides applications for clients or users. Application server 150 may provide services including multimedia content services, e.g., EPG, digital video recording (DVR), VOD, or PPVs, Internet protocol television (IPTV) portal, digital rights management (DRM) servers, navigation/middleware servers, conditional access systems (CAS), and remote diagnostics, as examples.

Applications provided by application server 150 may be downloaded and hosted on other network resources including, for example, content delivery server 160, switching network 140, and/or on clients 120. Application server 150 is configured with a processor and storage media (not shown in FIG. 1) and is enabled to execute processor instructions, such as those included within a software application.

Further depicted in FIG. 1 is database server 190, which provides hardware and software resources for data warehousing. Database server 190 may communicate with other elements of the resources of service provider 121, such as application server 150 or content delivery server 160, in order to store and provide access to large volumes of data, information, or multimedia content. In some embodiments, database server 190 includes a data warehousing application, accessible via switching network 140, that can be used to record and access structured data, such as product metadata or product information for placed products, as will be discussed in detail below.

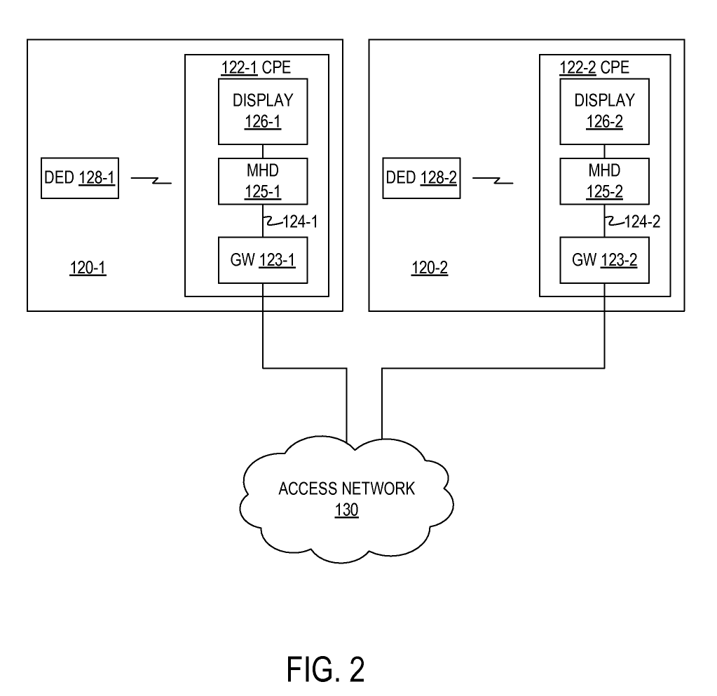

Turning now to FIG. 2, clients 120 are shown in additional detail with respect to access network 130. Clients 120 may include network appliances collectively referred to herein as client premises equipment (CPE) 122. In the depicted embodiment, CPE 122 includes the following devices: gateway (GW) 123, multimedia handling device (MHD) 125, and display device 126. Any combination of GW 123, MHD 125, and display device 126 may be integrated into a single physical device. Thus, for example, CPE 122 might include a single physical device that integrates GW 123, MHD 125, and display device 126. As another example, MHD 125 may be integrated into display device 126, while GW 123 is housed within a physically separate device.

In FIG. 2, GW 123 provides connectivity for client 120 to access network 130. GW 123 provides an interface and conversion function between access network 130 and client-side local area network (LAN) 124. GW 123 may include elements of a conventional DSL or cable modem. GW 123, in some embodiments, may further include routing functionality for routing multimedia content, conventional data content, or a combination of both in compliance with IP or another network layer protocol. In some embodiments, LAN 124 may encompass or represent an IEEE 802.3 (Ethernet) LAN, an IEEE 802.11-type (WiFi) LAN, or a combination thereof. GW 123 may still further include WiFi or another type of wireless access point to extend LAN 124 to wireless-capable devices in proximity to GW 123. GW 123 may also provide a firewall (not depicted) between clients 120 and access network 130.

Clients 120 as depicted in FIG. 2 further include a display device or, more simply, a display 126. Display 126 may be implemented as a TV, a liquid crystal display screen, a computer monitor, or the like. Display 126 may comply with a display standard such as National Television System Committee (NTSC), Phase Alternating Line (PAL), or another suitable standard. Display 126 may include one or more integrated or external speakers to play audio content.

Clients 120 as shown further include a display enablement device (DED) 128. In some embodiments, DED 128 is configured to enable a user to communicate with MHD 125 by means of a user interface (not depicted). DED 128 may be operable to communicate wirelessly with MHD 125, using infrared (IR) or radio frequency (RF) signals, applicable requests, commands, or motion states of DED 128. MHDs 125 may also receive requests or commands via physical or virtual buttons (not depicted) located on side panels of MHDs 125.

DED 128 may include one or more physical or virtual buttons, touch screen display elements, or other input devices (not depicted) for use in communicating with MHDs 125. In some embodiments, DED 128 may be suitable for being held by a user, may include functionality of general purpose remote control devices, and may include haptic technology to communicate with a user by way of vibration or other tactile indicators. In other embodiments, clients 120 may include a separate general purpose remote control device (not depicted) and, in these embodiments, DED 128 may omit remote control functionality. In some embodiments, DED 128 may not be configured for continuous movement by a user, but rather may be configured or adapted to monitor the motion of user within a specified detection area.

In addition, DED 128 may be configured to provide motion state information to MHD 125. Such motion state information may be collected using accelerometers and other motion sensing components and technology as are well known in the art. Further, applicable haptic interfaces may be effectuated using components and technology as are well known in the art. Examples of such motion and motion state sensing components and technology and haptic interface technology include the Wii® brand controllers and sensor bar manufactured by Nintendo®. In instances where DED 128 is not configured for continuous movement by a user, but rather is configured or adapted to monitor the motion of user within a specified detection area, motion state information of the user may be collected using video image capture and processing technology as is well known in the art.

MHD 125 is enabled and configured to process incoming multimedia signals to produce audio and visual signals suitable for delivery to display 126 and any optional external speakers (not depicted). Incoming multimedia signals received by MHD 125 may be compressed and/or encrypted, digital or analog, packetized for delivery over packet switched embodiments of access network 130 or modulated for delivery over cable-based access networks. In some embodiments, MHD 125 may be implemented as a stand-alone set top box suitable for use in a co-axial or IP-based MCDN. MHD 128 is configured to operatively communicate with DED 128 and based upon determinations made in accordance with one or methods disclosed herein, determine whether to provide received multimedia content to display 126 for display.

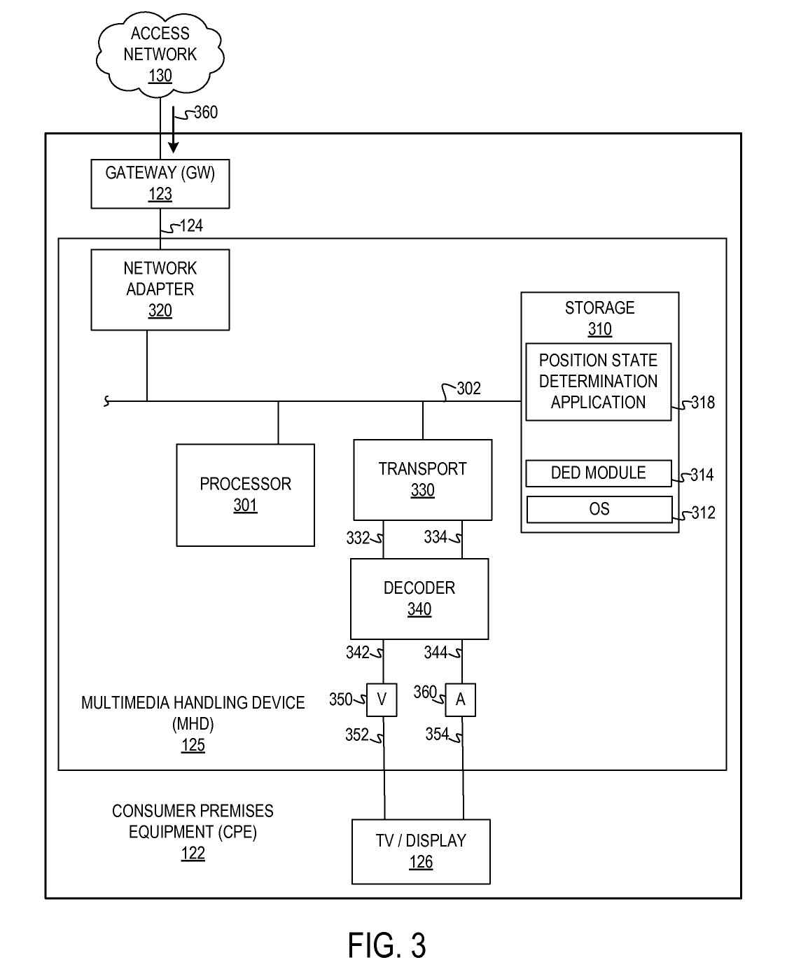

Referring now to FIG. 3, a block diagram illustrating selected elements of an embodiment of MHD 125 is presented. In FIG. 3, MHD 125 is shown as a functional component of CPE 122 along with GW 123 and display 126, independent of any physical implementation, as discussed above with respect to FIG. 2. In particular, it is noted that CPE 122 may be any combination of GW 123, MHD 125 and display 126.

In the embodiment depicted in FIG. 3, MHD 125 includes processor 301 coupled via shared bus 302 to storage media collectively identified as storage 310. MHD 125, as depicted in FIG. 3, further includes network adapter 320 that interfaces MHD 125 to LAN 124 and through which MHD 125 receives multimedia content 360. GW 123 is shown providing a bridge between access network 130 and LAN 124, and receiving multimedia content 360 from access network 130.

In embodiments suitable for use in IP based content delivery networks, MHD 125, as depicted in FIG. 3, may include transport unit 330 that assembles the payloads from a sequence or set of network packets into a stream of multimedia content. In coaxial based access networks, content may be delivered as a stream that is not packet based and it may not be necessary in these embodiments to include transport unit 330. In a co-axial implementation, however, clients 120 may require tuning resources (not explicitly depicted in FIG. 3) to “filter” desired content from other content that is delivered over the coaxial medium simultaneously and these tuners may be provided in MHDs 125. The stream of multimedia content received by transport unit 330 may include audio information and video information and transport unit 330 may parse or segregate the two to generate video stream 332 and audio stream 334 as shown.

Video and audio streams 332 and 334, as output from transport unit 330, may include audio or video information that is compressed, encrypted, or both. A decoder unit 340 is shown as receiving video and audio streams 332 and 334 and generating native format video and audio streams 342 and 344. Decoder 340 may employ any of various widely distributed video decoding algorithms including any of the Motion Pictures Expert Group (MPEG) standards, Windows Media Video (WMV) standards including WMV 9, which has been standardized as Video Codec-1 (VC-1) by the Society of Motion Picture and Television Engineers. Similarly decoder 340 may employ any of various audio decoding algorithms including Dolby® Digital, Digital Theatre System (DTS) Coherent Acoustics, and Windows Media Audio (WMA).

The native format video and audio streams 342 and 344 as shown in FIG. 3 may be processed by encoders/digital-to-analog converters (encoders/DACs) 350 and 360 respectively to produce analog video and audio signals 352 and 354 in a format compliant with display 126, which itself may or may not be a part of MHD 125. Display 126 may comply with NTSC, PAL or any other suitable television standard.

Storage 310 encompasses persistent and volatile media, fixed and removable media, and magnetic and semiconductor media. Storage 310 is operable to store instructions, data, or both. Storage 310 as shown includes sets or sequences of instructions, namely, an operating system 312, a DED application program identified as DED module 314, and a motion state determination application 318. Operating system 312 may be a UNIX or UNIX-like operating system, a Windows® family operating system, or another suitable operating system. In some embodiments, storage 310 is configured to store and execute instructions provided as services to client 120 by application server 150, as mentioned previously.

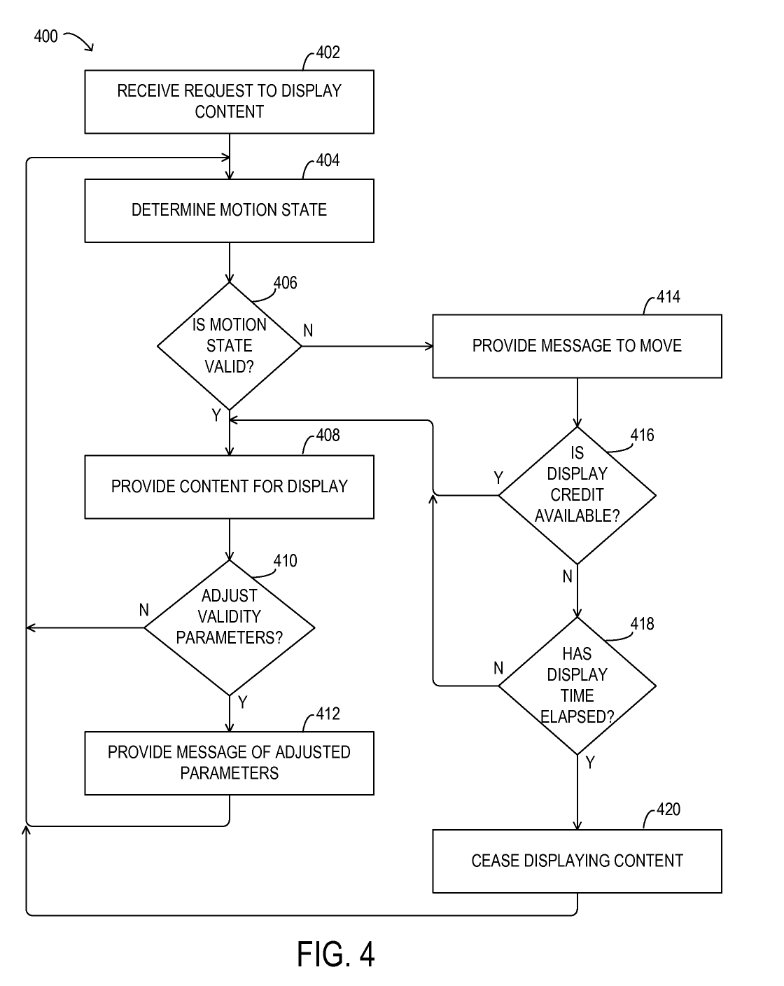

Referring now to FIG. 4, an embodiment of method 400 for controlling display of multimedia content is illustrated. In one embodiment, MHD 125, or another device associated with client 120, is configured to execute method 400. In some instances, motion state determination application 318 may include program instructions executable to perform at least some operations of method 400. Motion state determination application 318 may further include instructions to communicate with DED 128 using DED module 314 (see FIGS. 2-3).

In the embodiment depicted in FIG. 4, method 400 includes receiving a request to display (operation 402) multimedia content. The multimedia content may be a video or television program and the multimedia content may be received from the MCDN. Before outputting, releasing, rendering, or otherwise providing (i.e., forwarding or providing) the multimedia content to a display device, the motion state of a DED is determined (operation 404). If the motion state of the DED is determined (operation 406) to be valid, the requested multimedia content is provided (operation 408) for display. If the motion state is not valid, a message may be communicated for display separately or as an overlay on the multimedia program currently being provided for display. In another embodiment, such notice may be in the form of audible tone or other indicator, including a haptic indication provided through the DED or another device. The message may instruct the user to move or to move the DED.

As is noted in more detail below and as reflected in FIG. 4, the DED motion state is determined on a recurring basis. In one embodiment, the motion state is determined to be valid as long as the position of the DED is continually changed. In a further aspect, the position of the DED must be continually changed within a selected speed range in order for the motion state to remain valid. In yet another aspect, the motion state of the DED is determined to be valid as long as the position of the DED is continually changed in accordance with a selected pattern. The speed ranges and patterns may be those associated with the movements and routines of Chinese martial art known as tai chi or tai chi chuan as well as other exercise routines. In another embodiment, the motion state of the DED is determined to be valid if the user maintains a relatively constant position of the DED for a selected time period. The applicable motion state may also be determined as valid based upon a position of the DED relative to the body of a user manipulating the DED. For example, one such position may be the user maintaining a relatively constant position of the DED at the end of the user's extended arm. Within this application, valid motion states of the DED involving applicable ranges of speed, patterns, relative location, and the like are referred to as validity parameters.

Following the provision of the multimedia content for display, a determination is made as to whether to adjust (operation 410) current validity parameters. The determination may be made based on prior positions of the DED. In one embodiment, the speed range and pattern may be individually or collectively revised such that a varied routine for the user is effectuated. If a determination is made not to adjust current validity parameters, operation is returned to determining the motion state of the DED (operation 404). If a decision is made to adjust the validity parameters, notice is provided (operation 412) regarding the adjustment. Such notice may be in the form of message or other indicator provided for display separately or as an overlay on the multimedia program currently being displayed. In another embodiment, such notice may be in the form of audible tone or other indicator, including a haptic indication provided through the DED or another device.

If the motion state of the DED is determined (operation 406) to be invalid, a message to move the DED is provided (operation 414). Such message may be in the form of a notice or other indicator provided for display separately. In another embodiment, such notice may be in the form of audible tone or other indicator, including a haptic indication provided through the DED or another device. A determination (operation 416) is then made as to whether a display credit is available. As used herein, the term display credit means a value which may be increased or otherwise adjusted should the motion state of the DED be determined to be valid for a predetermined or user selectable threshold (i.e., time period). If a display credit is available, the available display time is increased by some or all of the available display credit, the display credit is reduced accordingly, and the multimedia content is provided (operation 408) for display. If a display credit is not available, a determination is made (operation 418) as to whether the display time has elapsed. The display time may be selectively adjusted and is the amount of time during which the motion state of the DED may be determined to be invalid, but multimedia content continues to be forwarded for display. In one embodiment, the display time may be adjusted depending on the type of multimedia content requested such that an incentive is provided to view types or classes of multimedia content for which the display time may be increased. For example, if an incentive to view multimedia content available on the Public Broadcasting System (PBS) is desired, the display time may be increased when such PBS multimedia content is requested to be displayed. Request to view multimedia content consisting of cartoons may, however, result in a decrease to the display time if a disincentive to view such type of multimedia content is desired. If the display time has elapsed, providing the content for display is ceased (operation 420) and operation is returned to determining the motion state of the DED (operation 404).

Throughout this application, a motion state of the display enablement device, the position of which is controlled by a user, has been emphasized. It is to be understood, that the disclosed embodiments may also include a display enablement device that is not configured for continuous movement by a user, but rather is configured or adapted to monitor the motion of user within a specified detection area. In such embodiments, the motion state as discussed herein is that of the user and not the display enablement device and validity of the motion state as discussed herein is determined based upon the position and movement or non-movement of the user within a specified detection area, rather than the movement or non-movement of the display enablement device.

To the maximum extent allowed by law, the scope of the present disclosure is to be determined by the broadest permissible interpretation of the following claims and their equivalents, and shall not be restricted or limited to the specific embodiments described in the foregoing detailed description.

What is claimed is:

1. A method for controlling display of multimedia content, comprising:
receiving a request to display a multimedia program;
determining a motion state of a handheld display enablement device; and
determining, based on said motion state, whether to respond to the display request by providing the multimedia program for display.

2. The method of claim 1, wherein said determining of said motion state is conducted on a recurring basis.

3. The method of claim 2, further comprising:
responsive to determining not to provide the multimedia program for display, communicating to a user to move the display enablement device; and
responsive to continually determining not to provide the multimedia program for display for a first predetermined time period, ceasing the providing the multimedia program for display.

4. The method of claim 3, further comprising:
responsive to continually determining to provide the multimedia program for display for a predetermined second time period, increasing the first predetermined time period.

5. The method of claim 4, further comprising:
communicating to a user that said first predetermined time period has been increased.

6. The method of claim 2, wherein the motion state of the display enablement device is controlled by a user.

7. The method of claim 6, wherein said determining to provide the multimedia program for display occurs as long as the user continually changes a position of the display enablement device.

8. The method of claim 6, wherein said determining to provide the multimedia program for display occurs as long as the user continually changes a position of the display enablement device within a selected speed range.

9. The method of claim 8, wherein responsive to previous movements of the display enablement device by the user, the selected speed range is changed, and further wherein, the changed speed range is communicated to the user.

10. The method of claim 6, wherein said determining to provide the multimedia program for display occurs as long as the user continually changes a position of the display enablement device in accordance with a selected pattern.

11. The method of claim 10, wherein responsive to previous movements of the display enablement device by the user, the selected pattern is changed, and further wherein, the changed pattern is communicated to the user.

12. The method of claim 6, wherein said determining to provide the multimedia program for display occurs as long as the user maintains a relatively constant position of the display enablement device for a selected time period.

13. The method of claim 12, wherein responsive to previously maintaining the relative constant position of the display enablement device, the selected time period is changed, and further wherein, the changed time period is communicated to the user.

14. The method of claim 6, wherein determining to provide the multimedia program for display is based in part upon a position of the display enablement device relative to a predetermined part of the user's body.

15. The method of claim 14, wherein the predetermined body part is at the end of the user's extended arm.

16. A multimedia handling device (MHD) comprising:
a processor;
a network adapter configured to receive multimedia content; and
memory media accessible to the processor, including instructions executable by the processor to:
receive a request to display a multimedia program;
communicate a message to move a display enablement device;
determine a motion state for the display enablement device; and
continually determine, based on said motion state, whether to respond to the display request by providing the multimedia program for display.

17. The MHD of claim 16, further comprising processor instructions executable to:
provide a message to move the display enablement device in response to detecting an invalid motion state; and
responsive to detecting an invalid motion state for a predetermined time period, cease providing the multimedia content for display.

18. The MHD of claim 17, wherein the duration of the predetermined time period is dependent on the type of multimedia program being provided for display.

19. The MHD of claim 16, wherein the motion state is valid while the user continually changes the position of the display enablement device or while the user maintains a relatively constant position of the display enablement device for a selected time period.

20. Computer-readable memory media, including instructions for controlling display of multimedia content, said instructions executable to:
continually detect a motion state;
continually determine whether said motion state is valid; and
responsive to a valid motion state, provide a multimedia program for display.

21. The memory media of claim 20, further comprising instructions executable to:
responsive to an invalid motion state, provide a message to move; and
responsive to a continually invalid motion state for a predetermined time period, cease provision of the multimedia program for display.

22. The memory media of claim 21, wherein the predetermined time period is adjusted based upon the value of a display credit.

23. The memory media of claim 21, wherein the predetermined time period is adjusted based upon the multimedia program being displayed.

24. The memory media of claim 23, wherein responsive to a classification of the multimedia program within a preferred viewing class, the adjustment resulting in an increase to the predetermined time period.

25. The memory media of claim 20, wherein the motion state is determined to be valid while the position of a display enablement device is continually changed.

26. The memory media of claim 20, wherein the motion state is determined to be valid while the position of a display enablement device is maintained in a relatively constant position for a predetermined period of time.

27. The memory media of claim 20, wherein the motion state is determined to be valid while a user continually moves.

28. The memory media of claim 20, wherein the motion state is determined to be valid while a user maintains a relatively constant position for a predetermined period of time.
